(19) United States
(12) Patent Application Publication
(10) Pub. No.: US 2009/0022485 A1
(43) Pub. Date: Jan. 22, 2009

(54) Airudry rug

(76) Inventor: Wallace Charles Madden, Atlanta, GA (US)

Correspondence Address: J.T. HOLLIN, ATTORNEY AT LAW, PC, 110 HABERSHAM DRIVE, SUITE 144, FAYETTEVILLE, GA, 30214, US

(21) Appl. No.: 12/218,445

(22) Filed: Jul. 15, 2008

Related U.S. Application Data
(60) Provisional application No. 60/959,593, filed on Jul. 16, 2007.

(51) Int. Cl. A47K 10/48; F26B 9/00; F26B 25/00

(52) U.S. Cl. 392/380; 392/382; 34/618; 34/239

(57) ABSTRACT

Disclosed is a apparatus which functions as a personal body-drying device for an individual whose skin is wet immediately after a bath or shower. The device is essentially a rug attached atop a platform, with the said rug exposed at its bottom surface to at least one plenum chamber, or to a network of ducting. Both the rug and the network of ducting are constructed with regularly-spaced, co-located openings through which heated air is propelled. In the optimum mode of operation, each plenum chamber contains an electric heating element over which passes air driven by fans which are attached, at their air outlets, to the respective plenum chambers.

There is no joint research agreement involved with respect to this application.

### BACKGROUND OF THE INVENTION

(1) Field of the Invention

The inventive concept presented in this application relates to a device for drying the body, after a shower or bath, by means of streams of heated air passing upward through a rug.

(2) Description of the Related Art

In 1973, a device for drying the body of a person was disclosed. Said device comprised two porous towels arranged around or adjacent to two fans or blowers which blew heated air directly onto the towels U.S. Pat. No. 3,711,958, (Lepage, 1973). As the towels flowed and waved in the flow of warm air, the wet body of a person standing against the opposite side of the towels was dried thereby.

An inventor discloses a hot air welcome mat comprising a hot air forming chamber and a snow/water receiving chamber separated by a partition in U.S. Pat. No. 4,258,248 (Campo, 1981). When a user's foot steps onto the device's grill cover, an electric switch activates a hot air blower situated between the two chambers.

U.S. Pat. No. 4,782,601 (Gonzalez, 1988) revealed a foot drying assembly comprising an apertured grid structure which forms a platform capable of supporting the weight of a person. Directly adjacent to the platform and forming an integral part thereof, is a fan assembly which blows heated air through the innards of the platform, said heated air being re-directed in an upward direction onto the feet of a person standing on the platform.

In U.S. Pat. No. 4,871,900 (Hickman, 1989) the inventor discloses a body air dryer consisting of a hot air dryer suspended from the ceiling. The heated air is directed downward into flexible tubes which form a chamber resembling a skirt-type arrangement, within which chamber stands a person. Interior slots, which are built into the chamber arrangement, allow heated air to escape to the interior of the chamber, thereby drying the user inside.

A personal body dryer comprising a 4-legged platform constructed with a plurality of apertures in the upper horizontal surface of the platform is disclosed in U.S. Pat. No. 5,007,182 (Fishman, 1991). Underneath the surface of the platform, and centered equidistant from the four legs, is a motorized fan which forces air upward through the apertures onto the body of a user standing on the platform.

U.S. Pat. No. 5,157,850 (Terng-Shuh, 1992 discloses a “sole dryer” comprising two electric blowers which blow heated air currents through a horizontally-arranged protective grid structure. A fabric cover is fastened so as to overlay the grid structure. The user places his/her “soles of the legs” upon the covered structure, thereby exposing the soles to the drying air currents.

A foot dryer with a weight scale is presented in U.S. Pat. No. 5,613,304 (Lin, 1997) comprising an upper housing for drying the soles of the feet of a user standing on the structure, and a lower housing containing mechanisms for simultaneously weighing the user. The upper housing further contains a heater and a fan for directing drying air into left and right footplates, each footplate containing a plurality of small apertures.

An aerated flooring system consisting of a ventilation system with an airflow shaft under the floor of a gymnasium or similar structure is disclosed in U.S. Pat. No. 6,279,279 (Larrimore, 2001). A large, computer-controlled blower provides air circulation through air shafts near the junctions of the floor and walls of the structure.

U.S. Patent Application Publication #US2004/0159001 (Ross, 2004) discloses a personal dryer constructed in the form of a vertically-elongated rectangular box. A computer controlled device regulates and mixes the flow and temperature of two separate air streams generated by mechanisms within the box. A user standing inside the box manually selects the most comfortable combination of airflows and temperature for body drying.

Disclosed in U.S. Pat. No. 6,842,581 (Schafer, 2005) is a body drying system comprising a tower of stacked cylinders. Each cylinder contains a fan housing assembly which blows air across an internal heating coil. The cylinders are interconnected electrically, thereby enabling the selection of drying air from any combination of cylinders. Each cylinder is enclosed in a protective grill for safety of the user, who stands proximate the tower while in the process of body drying.

### BRIEF SUMMARY OF THE INVENTION

This inventive concept presents an apparatus which provides personal grooming to a person who is in the process of drying his/her body immediately after a bath or shower. Essentially, in the best mode of operation, heated air is circulated by electrically powered fans through the confines of a plurality of ducts located directly beneath the bottom surface of a rug upon which the person is standing.

A grated platform, when placed on a floor or other surface, supports the weight of a person and the contours of ducting networks. At opposite ends of the grated platform are plenum chambers, each plenum chamber being connected at one if its ends to the outlet of a fan, and on its opposite end to the entry point of its respective ducting network. Within each plenum chamber are electrical heating elements over which passes the volumes of air propelled by the fan. The grated platform conforms to the contours of the ducting networks, thereby retaining the structural integrity of the ducting networks and also providing a level and secure means of support for the rug.

Regularly-spaced, co-located apertures in the ducting networks, the grated platform, and the rug allow and direct the flow of the heated air upward into the ambient space surrounding a user, thus enhancing the drying of the wet, exposed skin of the user as he/she stands on the rug.

### BRIEF DESCRIPTION OF THE VIEWS OF THE DRAWINGS

FIG. 1 depicts an exploded view of the basic components of the inventive concept, including, from top to bottom, the rug, the ducting network, and the grated support platform.

FIG. 2 is a three-dimensional view of the ducting networks, in particular, the conduits stemming from the left and right plenum chambers.

FIG. 3 presents a plan view of the grated platform, with the displayed embodiment depicting the indentations in the platform necessary for accommodation of the ducting network and the positioning of the fans at each end of the platform.

FIG. 4 illustrates a side view of the grated platform as shown in FIG. 2, including the fans, conduits, and left, center, and right exhaust ports.

FIG. 5 shows a three-dimensional view of the grated platform as seen from a downward-looking perspective.

FIG. 6 illustrates a three-dimensional view of the rug and its regularly-spaced apertures, which correspond to the exhaust ports of the ducting network.

FIG. 7 is a rendition of a typical user standing atop the rug as the warm air streams are emitted.

### GLOSSARY OF COMPONENTS

1. Rug
2. Grated platform
3. Screen
4. Left dual fan unit
5. Right dual fan unit
6. Left forward plenum chamber
7. Left rear plenum chamber
8. Right forward plenum chamber
9. Right rear plenum chamber
10. Electrical heating element
11. Electrical connection
12. Electric power cord
13. Control switch
14. Left forward conduits
15. Left rear conduits
16. Right forward conduits
17. Right rear conduits
18. Left forward exhaust ports
19. Left rear exhaust ports
20. Center forward exhaust ports
21. Center rear exhaust ports
22. Right forward exhaust ports
23. Right rear exhaust ports
24. Left platform openings
25. Center platform openings
26. Right platform openings
27. Left shroud
28. Right Shroud
29. Left ducting network
30. Right ducting network
31. Rug aperture
32. Platform channel
33. Left fan housing
34. Left fan outlet
35. Right fan housing
36. Right fan outlet

### DETAILED DESCRIPTION OF THE INVENTION

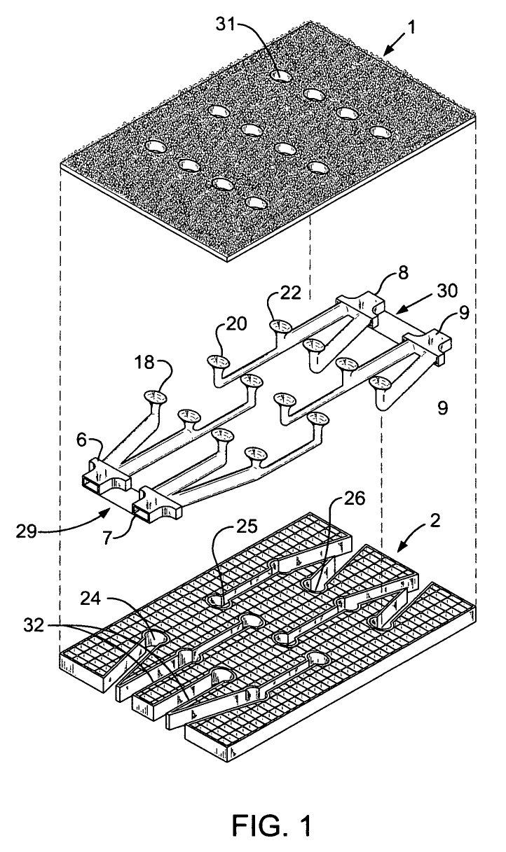

In referring to FIG. 1, the overall display of the basic static components of a particular embodiment of the inventive concept are shown, including the rug 1, the left ducting network 29, the right ducting network 30, and the grated platform 2. These components are assembled in a stacking fashion, with the grated platform 2 structured with platform openings 24, 25, 26 and concave channels 32 to specifically accept the bottom contours of the left and right ducting networks, 29 and 30 as the ducting networks are placed directly atop the grated platform 2. In similar fashion, the rug 1 contains a plurality of elliptical apertures 31 which correspond to the locations of the platform openings 24, 25, 26.

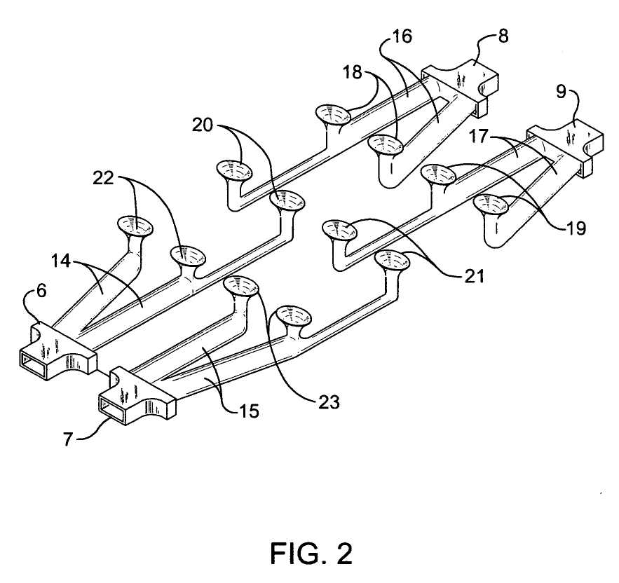

FIG. 2 presents an expanded perspective of the left and right ducting networks 29, 30. The left plenum chambers 6, 7 direct airflow from the left dual fan unit 4 into the left forward conduits 14 and left rear conduits 15. The said conduits 14, 15 then channel the airflow into four orthogonally oriented left exhaust ports, 22 and 23 and into two center exhaust ports, 20 and 21. Right-side plenum chambers 8, 9 direct airflow from the right dual fan unit 5 into the right forward conduits 16 and right rear conduits 17. The said conduits 16, 17 then channel airflow into four orthogonally oriented right exhaust ports, 18 and 19 and into two center exhaust ports, 20 and 21.

In the embodiment shown in FIG. 2, it can be seen that the ducting networks 29, 30 function as two similar systems, laid out in opposite orientations. As the dual fan units 4 and 5 are electrically switched on, substantial volumes of air course through the conduits 14, 15, 16, 17 and the air is expelled upward through the regularly-spaced exhaust ports, 18, 19, 20, 21, 22, and 23. The said exhaust ports are located to correspond with the location of rug apertures 31, thus enabling a stream of warm air to be emitted upwards onto the body of a user.

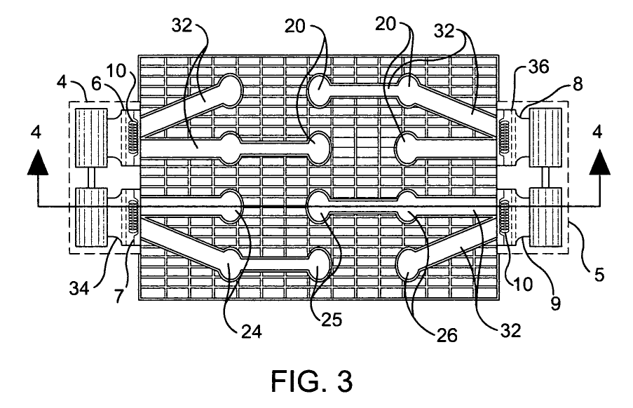

In viewing FIG. 3, a plan view of the grated platform 2 is presented. Included in this view are unobstructed downward-looking views of the left dual fan unit 4, the left plenum chambers 6, 7, the right dual fan unit 5, and the right plenum chambers 8, 9. Each of the left plenum chambers 6, 7, and the right plenum chambers 8, 9 are also shown to contain a heating element 10. An optional fragrance generating device may be attached in any one of the plenum chambers, just downstream of the heating element 10.

The left side of the grated platform 2 indicates four left platform openings 24 and additionally, four indented platform channels 32 (typical) which are designed to accommodate the left side conduits 14, and 15. The right side of the grated platform 2 illustrates four platform openings 26 and four indented platform channels 32 into which the right conduits 16, 17 will be placed upon assembly of the entire device. Four center platform openings 25 allow a direct fit over the center exhaust ports 20, 21 of the left and right ducting networks 29, 30.

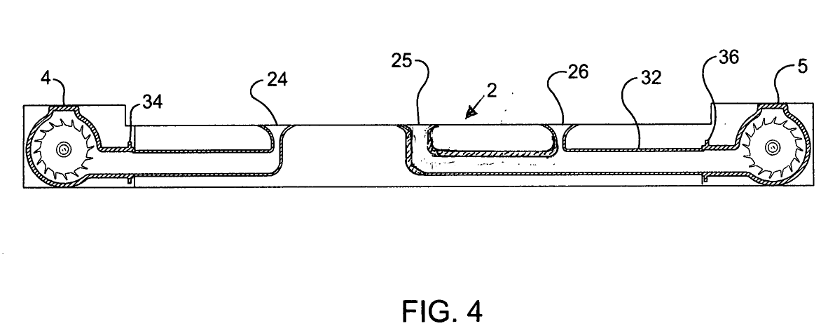

In referring to FIG. 4, a cutaway side view of FIG. 3 is presented, wherein the orientation of the dual fan units 4, 5 is shown relative to the grated platform 2, the platform channels 32, and the platform openings 24, 25, and 26. As can be seen from this perspective, the center platform openings 25 comprise a larger diameter than the left and right platform openings, 24, 26. This feature is to compensate for the fact that the center platform openings 25, and consequently the center exhaust ports 20, 21, are at a greater distance from each respective fan outlet 34, 36 than are the left and right exhaust ports, 18, 19, 22, and 23. In this manner the volumetric flow rate is rendered approximately equal at the smaller and the larger exhaust ports.

The left and right fan housings 33, 35 are constructed and joined to the respective fan air outlets 34, 36 with airtight sealants to prevent water seepage onto any internal electrical wiring.

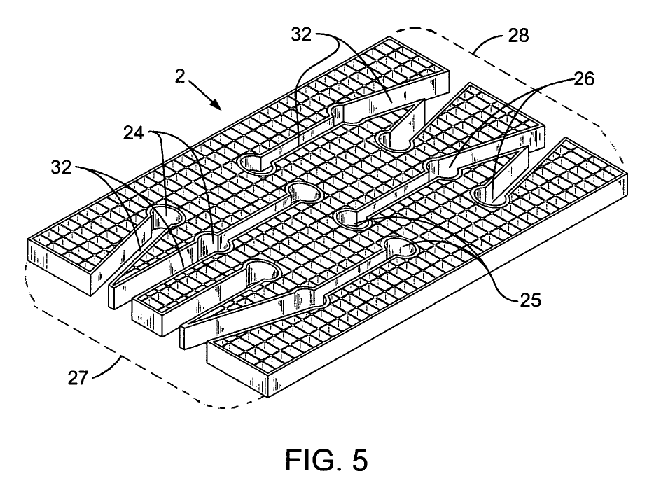

As we view FIG. 5, the grated platform 2 is shown in perspective. The material used in constructing the grated platform 2 is of sufficient rigidity and strength so as to support the weight of an adult human standing upon the rug 1, as attached to the upper surface of the grated platform 2. The innards of the grated platform 2 contain indented channels 32 which are of a specific radius and length to snugly accommodate the conduits of the left ducting network 29 and the right ducting network 30. The vertical distance between the upper surface and the undersurface of the grated platform 2 is such as to allow the entirety of the diameter of the conduits of both ducting networks 29, 30 to fit within the vertical confines of the grated platform 2. The undersurface of the grated platform 2 is characterized by open-spaced grids so as to allow drainage of excess water completely through the platform 2 and onto the floor or other supportive surface.

The grated platform 2 is further constructed with platform openings, 24, 25, and 26, several of which are referenced in the drawing. Said platform openings 24, 25, 26 accommodate the exhaust ports of said conduits 14, 15, 16, 17 of said ducting networks 29, 30. A left shroud 27 and a right shroud 28, although not set out in specifics in this drawing, may be hingedly connected to each respective end of the grated platform 2.

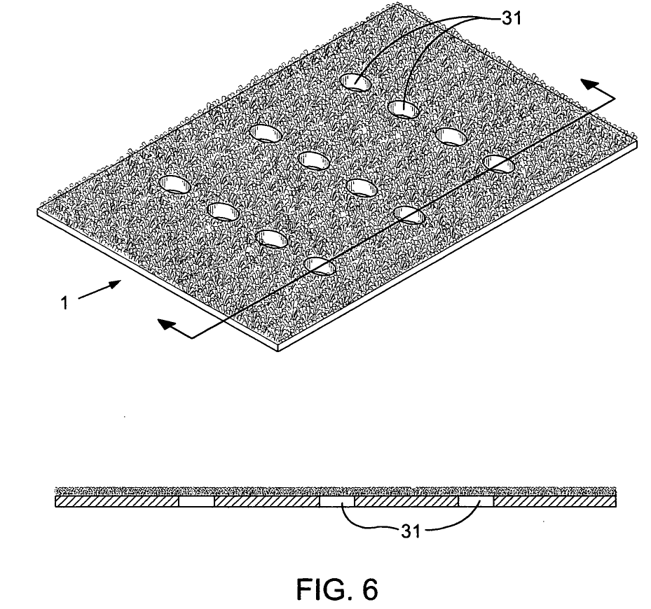

FIG. 6 displays two views of the rug 1 and its series of apertures 31. The underside of the rug 1, when in use, will be placed directly atop the upper surface of the grated platform 2 and suitably attached thereto. As the rug 1 is placed atop the grated platform 2, the rug apertures 31 will be concentric with, and be superimposed over the exhaust ports 18, 19, 20, 21, 22, 23 of the left and right ducting networks 29, 30. The rug 1 will be composed of sufficient height of nap so as to provide a smooth and comfortable transition for a user, as the feet will simultaneously feel the upper rim of the exhaust ports 18, 19, 20, 21, 22, 23 and the top surface of the rug 1 as a seamless foundation.

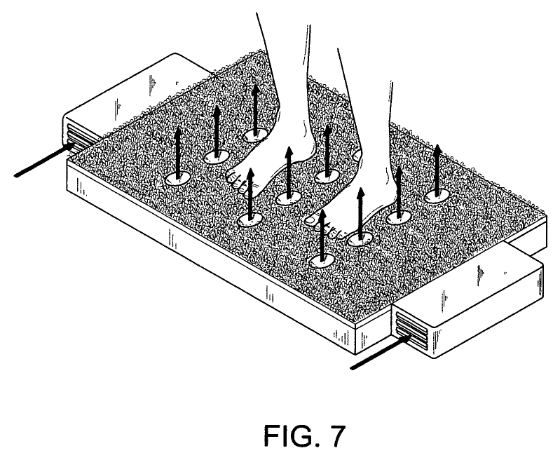

FIG. 7 demonstrates the typical positioning of a user while standing on the device.

A primary objective of the inventive concept is to provide a relatively luxurious means of personal drying following a bath or shower. In that regard, the quality of material selected for the rug 1 will play a role in determine the comfort and aesthetic appeal of the device. Likewise, the hinged shrouds 27, 28 will also positively affect the overall appearance, integrity, and soundproofing of the device.

This inventive concept, although presented with reference to the particularly described embodiments and descriptions, is not limited to these descriptions and the accompanying drawings. On the contrary, persons skilled in the art will recognize the possibility of various modifications and enhancements. Nevertheless, such modifications or enhancements, if applied or utilized, will not be a departure from the scope, spirit, and intent of the present inventive concept as set forth in the claims herein.

What is claimed is:

1. A personal body drying device, comprising:
at least one fan, said at least one fan enclosed in a housing wherein said housing defines an air inlet and an air outlet for airflow generated by said at least one fan;
a platform having a horizontal upper surface and a horizontal undersurface, and said platform further having a plurality of concentric apertures, said apertures allowing passage of air between said upper surface and said undersurface
a plenum chamber having two openings, one opening connected to the air outlet of said at least one fan, and the remaining opening proximate the undersurface of said platform; and
a rug, having a plurality of openings, said rug being attached to the upper surface of said platform.

2. A device as in claim 1, further comprising a ducting network, said ducting network comprising a series of conduits functioning as an air distribution mechanism between said plenum chamber and the undersurface of said platform.

3. A device as in either claim 1 or claim 2 further comprising an electrical heating element affixed to at least one wall of said plenum chamber.

4. A personal body drying device, comprising:
two fans, one on the left side, and one on the right side of said device, each fan further enclosed in a housing wherein said housing defines an air inlet and an air outlet;
a left-side plenum chamber, and a right-side plenum chamber each said plenum chamber having an inflow opening and an outflow opening;
a left-side ducting network comprising conduits, and a right-side conducting network comprising conduits, said left-side ducting network originating proximate the outflow opening of said left-side plenum and said right-side ducting network originating proximate the outflow opening of said right-side plenum;
a plurality of upwardly vertical exhaust ports connected to said conduits;
a grated platform having an upper surface and an undersurface, said grated platform further having a plurality of integral concave channels arranged in a manner as to accommodate the contours of said ducting networks;
a rug attached to the upper surface of said platform, said rug further having a plurality of openings, said openings corresponding to the location of said exhaust ports of said conduits

5. A personal body drying device as in claim 4, further comprising:
an electrical power cord;
an “on-off” switch a plurality of electric heating elements, at least one said electric heating element attached to at least one wall of each of said plenum chambers; and
a means of wiring for the distribution of internal electrical power to the components of said device.
